(19) United States
(12) Patent Application Publication
(10) Pub. No.: US 2006/0207820 A1
(43) Pub. Date: Sep. 21, 2006

(54) Active Vehile Shield

(76) Inventors: Hemant Joshi, Milpitas, CA (US); Jaya Joshi, Milpitas, CA (US)

Correspondence Address: HEMANT JOSHI, 1260 STARDUST WAY, MILPITAS, CA, 95035, US

(21) Appl. No.: 10/907,100

(22) Filed: Mar. 20, 2005

(51) Int. Cl. B60K 28/00

(52) U.S. Cl. 180/271

(57) ABSTRACT

An invention is disclosed for having an ‘active external vehicle shield’ which deploys on detection of an ‘imminent collision’ condition. This ‘invention’ provides a shield, which is fully deployed around the vehicle before the collision happens. When the collision happens this shield absorbs most of the collision energy, resulting in reduction of the risk of injury to the occupants of the vehicle.

### FIELD OF INVENTION

The present invention relates generally to devices that protect the vehicle from external impacts. This invention relates more particularly to the devices that actively scan for the ‘imminent collision’ condition and deploys the protective-shield even before the collision happens which minimizes the chances of bodily injuries.

### DESCRIPTION OF THE RELATED ART

The prior art devices that protect the occupants of an automobile externally are ‘bumpers’ located on front and rear of the vehicle. In addition to this, the vehicle also have crumple zones which when impact happens absorb the energy of collision. The objective is to protect the occupants of the vehicle and minimize the injuries. However these devices only become engaged when the impact happens. Hence for a high-speed collision, especially the worst type ‘head on’ they can't dissipate all the energy, which can result in serious injuries to the occupants of the vehicle.

The ‘method’ or ‘invention’, which is discussed in following sections, will actively scan for the hazards like collisions with a moving or stationary object. When the device detects ‘imminent collision’ then it will engage itself as a protective shield around the vehicle, depending upon the impact area. When the collision happens it will absorb the energy and then the other devices can get engaged to dissipate remaining energy. Thus this will both dissipate the energy and reduce the rapid deceleration of the vehicle resulting in reduction of the risk of serious injuries to the occupants of the vehicle.

In this ‘invention’ prior art electronic and mechanical components are used to show the implementation details. The prior art ‘embedded microprocessor’ will be the computing device that will scan for the hazards and make all the decisions regarding the deployment of shield. The prior art mechanical components will make part of the shield that will be activated around the vehicle depending upon the calculated impact location. The prior art electronic sensors that detect the speed of the vehicle, distance between the vehicles will be used as needed.

### SUMMARY OF THE INVENTION

Broadly speaking, the present invention makes the automobiles safer. It protects the occupants of the vehicle from serious injuries. In this section various preferred embodiments of the device are discussed.

In one embodiment the device will be attached to the front of the vehicle and will protect the front-end of the vehicle, it will deploy when the imminent frontal collision situation is detected.

In yet another embodiment the device will be attached to the rear of the vehicle and will protect the rear of the vehicle, it will deploy when the imminent rear-end collision situation is detected.

In yet another embodiment the device will be attached to the side of the vehicle and will protect the sides of the vehicle, it will deploy when the imminent side crash situation is detected.

In yet another embodiment the device will be integral part of the front of the vehicle and will protect the front-end of the vehicle, it will deploy when the imminent frontal collision situation is detected.

In yet another embodiment the device will be integral part of the rear of the vehicle and will protect the rear of the vehicle, it will deploy when the imminent rear-end collision situation is detected.

In yet another embodiment the device will be integral part of the side of the vehicle and will protect the sides of the vehicle, it will deploy when the imminent side crash situation is detected.

### DETAILED DESCRIPTION OF THE PREFERRED EMBODIMENTS

In the following description, numerous specific details are set forth in order to provide a thorough understanding of the present invention. It will be apparent, however, to one skilled in the art that the present invention may be practiced without some or all of these specific details. In other instances, well known process steps have not been described in detail in order not to unnecessarily obscure the present invention.

The prior art bumpers protect the front and rear of the vehicle by absorbing the crash energy. However for a serious collision there is still a lot of residual energy left that gets to the crumple zone and subsequently to the occupants of the car resulting in serious injuries to the occupants.

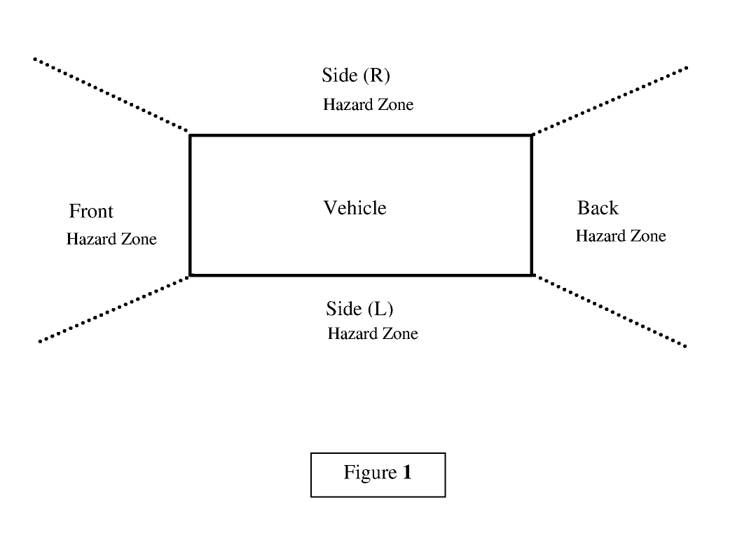

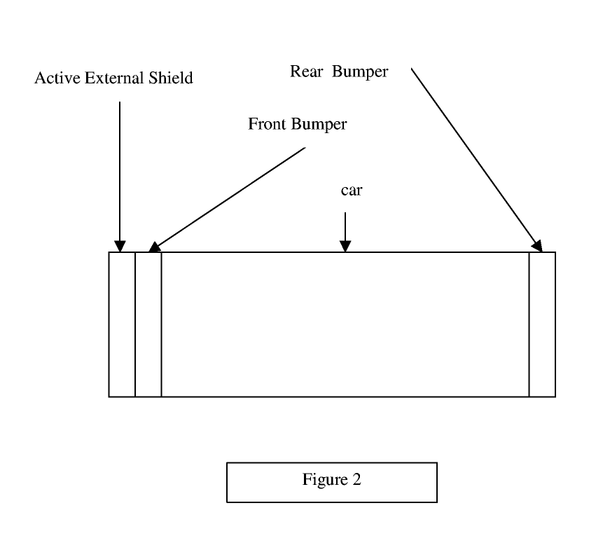

The invention is based upon scanning for hazards in a pre determined ‘hazard zone’. In this zone the sensors continuously scan for potential hazards. FIG. 1, shows hazard zones for different position of the ‘active external shield’ device. The FIG. 1 shows four hazard zones. One each on front and rear namely ‘Front’ and ‘Rear’, one on each side namely ‘side (R)’, ‘side (L)’. This zone is programmed based upon location of the ‘active external shield’; the ‘embedded microprocessor’ running the ‘embedded software’ controls it. The ‘embedded microprocessor’ can also dynamically shrink or expand the ‘hazard zone’ based upon certain dynamic parameters like speed of the vehicle, visibility conditions etc. FIG. 2, shows the ‘active external vehicle shield’ attached to the front bumper of a car, as an example block diagram.

The main components of ‘active external vehicle shield’ are as follows:

Computer: This is based upon a prior art ‘embedded microprocessor’; it gets the feedbacks from the sensor array. The sensor array is capable of detecting the motion and distance of the objects in the pre determined ‘hazard zone’. The prior art ‘embedded microprocessor’ executes the prior art ‘embedded software’ that scans for the hazards while the vehicle is moving. When the vehicle starts, it initializes all the subsystems. The hazards it scans are located in a predetermined ‘hazard zone’. In this ‘hazard zone’ the ‘relative speed’ of the vehicle with respect to the objects as well as the distance is used to detect imminent collision. The device contains the sensors that scan for the relative speed of the vehicle with respect to the objects in the hazard zone. These objects can be stationary or moving. For example there can be another vehicle coming head on or it can be a stationary pole. In addition to the ‘relative speed’ the sensors also monitor for the distance of the object from the vehicle. When the distance of the object become less then a pre-programmed value or the ‘relative speed’ crosses certain threshold, the ‘embedded microprocessor’ sets itself to ‘armed’ state and when the object moves out of this zone it ‘disarms’ again. The ‘armed’ state of this device can be displayed; in this state the device becomes more sensitive to any further changes in any of the parameters namely ‘relative speed’ or ‘object distance’, also it activates certain electromechanical components. The ‘embedded microprocessor’ keeps on monitoring these two main parameters namely ‘relative-speed’ and the ‘object distance’. Based upon the pre-programmed definition, the ‘relative-speed’ and the ‘object distance’ parameter, the ‘embedded microprocessor’ detects the ‘imminent collision’. When the collision is ‘imminent’ a shield is deployed using electromechanical devices part of the present ‘invention’. This deployment happens very fast and is timed such that the shield is fully deployed well before the collision happens.

The ‘embedded microprocessor’ has ports that can also connect to the ‘computer’ of the vehicle. This can enable displaying the information regarding the status of the device on vehicle's main console. Additionally this ‘embedded microprocessor’ can be integrated as a part of the vehicle's computer.

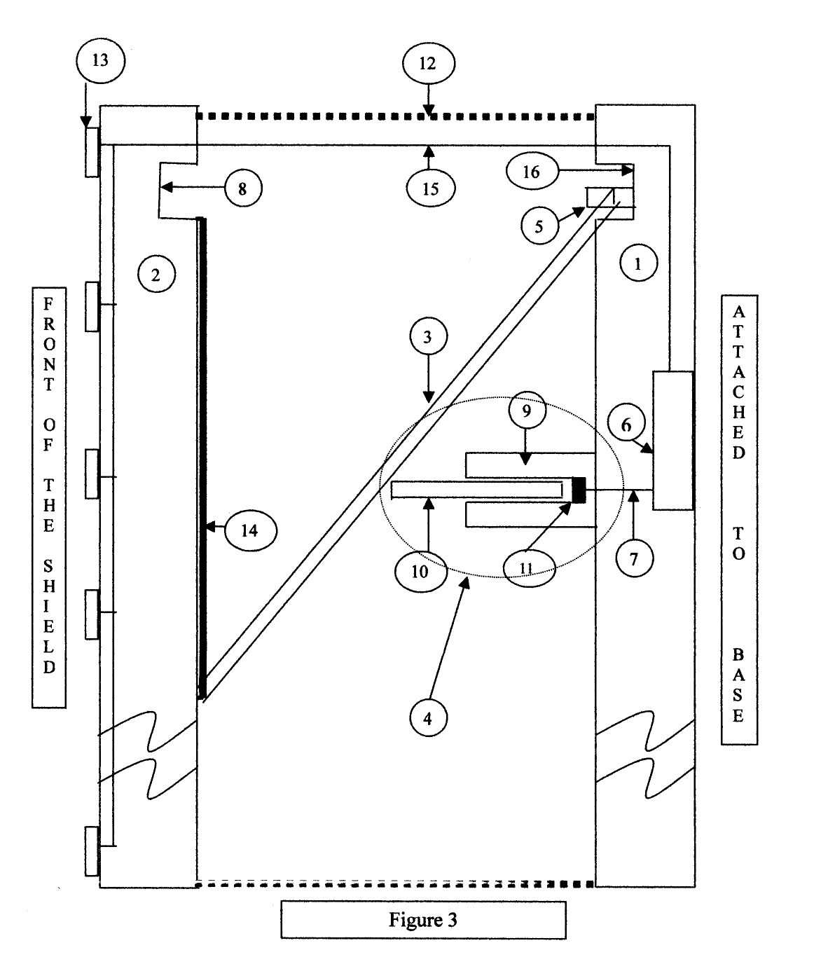

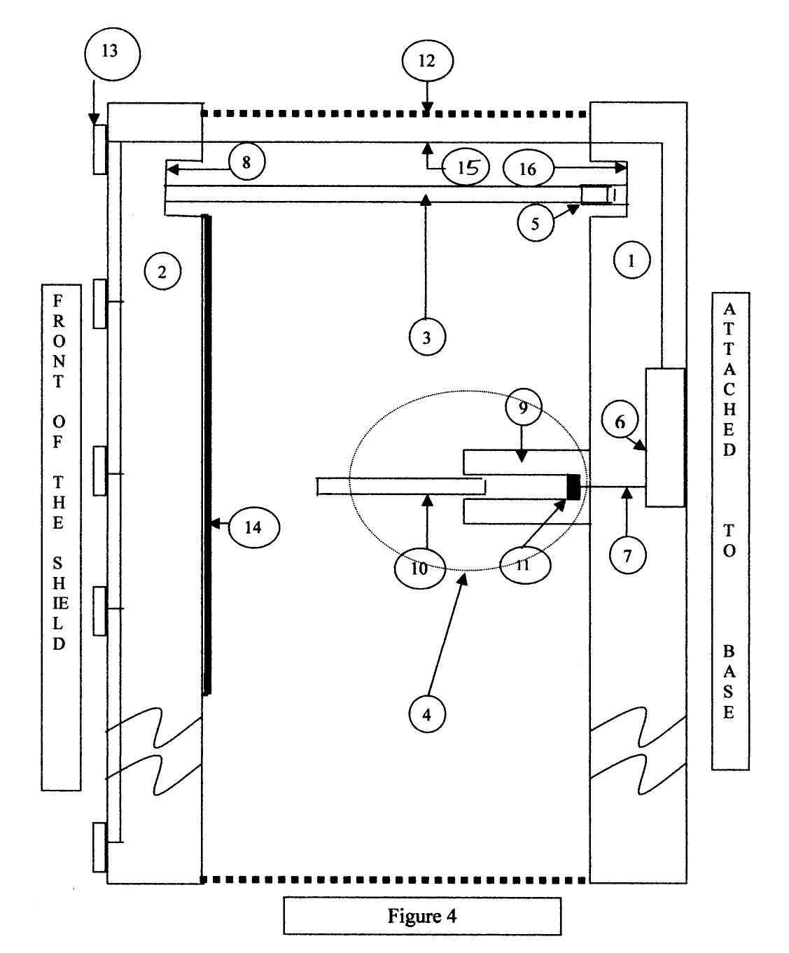

Shield: This shield is made up of electromechanical components. One of the main part is the shield which remains in ‘dormant’, ‘compressed’ condition until it is activated by ‘embedded microprocessor’ when imminent collision is detected. When ‘activated’ or ‘deployed’ it expands and extends further out of the boundaries of the vehicle to provide protection. The shield also houses all the electronic components and attaches to the ‘vehicle’ on one of its sides known as ‘base’. As an example it can be attached to the front bumper or replace it as shown in FIG. 2. The shield when in ‘dormant’, ‘compressed’ state looks as in FIG. 3. It is composed of multiple units, which are interconnected. Each unit is mainly composed of base (1), impact zone (2), impact absorption plate (3) and impact absorbing plate-positioning system (4). The impact absorption plate (3) and impact absorbing plate-positioning system (4) repeats multiple times inside the same base (1) and the impact zone (2). The impact absorption plates (3) remain in bent position as shown in FIG. 3, but when they gets pushed to perpendicular position to the base they extend the ‘impact zone’ (2) further out of the boundaries of the vehicle as shown in FIG. 4. The details of each of these parts is as follows:
(1) The ‘base’ (1) of the unit contains houses one of the ends of the ‘impact absorbing plate’. When the ‘impact absorbing plate’ becomes perpendicular it locks one of the ends in the groove (16) as shown. This plate moves inside the groove (16) using assembly (5). This groove doesn't let the plate move out of perpendicular position. Also this base (1) attaches to the vehicle on one of its sides, as an example in FIG. 2 to the bumper. In addition to that the base houses the ‘embedded microprocessor’ (6). There is only one ‘embedded microprocessor’, which is shared for all the units situated in the base (1). In case the shield is integrated to the main vehicle the ‘embedded microprocessor’ can be made a part of the vehicles main computer. The base (1) also attaches to the impact absorbing plate-positioning system (4); the control signal to this system (7) also passes from base to the ‘embedded microprocessor’ (6). The flexible cover of the shield (12) can stretch or tear when the shield is deployed to allow ‘impact zone’ to move out.
(2) The ‘impact zone’ (2) is made up of shock absorbing material. It houses the prior-art sensors array (13) that detects the ‘relative speed’ and the ‘distance’ of the objects in the ‘hazard zone’. It has a groove (8) that locks the impact absorption plate (3) to a perpendicular position and don't let it move out of that position. It also houses all the wires coming out of the sensors (15) and passes them so that they can attach to the ‘embedded microprocessor’ (6).
(3) The ‘impact absorption plate’ (3) is made up of a material that absorbs the shock and crumples when the perpendicular force is applied and absorbs most of the energy. It tightly fits in to the grooves (5) and (8) when put into the perpendicular position with respect to base (1) and impact zone (2). It slides onto an assembly (14) when piston (10) pushes it with force; this assembly (14) guides it to the groove (8) where it locks in perpendicular position.
(4) The ‘impact absorbing plate-positioning system’ (4) is made up of a high strength outer cylinder (9), a high strength piston (10) and the explosive charge (11). This explosive charge can be exploded using a trigger through wire (7), which is connected to ‘embedded microprocessor’ (6).

Sensors: The prior-art sensors array (13) is mounted on the outer surface of the impact zone (2) FIG. 3. These sensors are used to continuously fetch data regarding the ‘relative speed’ and ‘distance’ of the object in the ‘hazard zone’. This data is fed directly to ‘embedded microprocessor’ located on the ‘base’ (1) using signal wires (15).

Operational Mechanism: When the vehicle starts the ‘embedded microprocessor’ initializes itself and all it's subsystems. It immediately starts scanning for the potential hazards in the ‘hazard zone’. Once the potential hazard (moving or stationary object) is detected inside a pre-determined zone and/or the relative speed of the potential hazard (object) crosses a pre-determined threshold the ‘embedded microprocessor’, ‘arms’ the system. In this state it's scanning becomes more sensitive and it also gets all the subsystems ready to deploy the ‘shield’. When the potential hazard either moves away and/or it's relative speed becomes less then a threshold the ‘embedded microprocessor’, ‘disarms’ the system. When the system is ‘armed’ and based upon the ‘relative speed’ and ‘object distance’ if the computer detects imminent collision, it explodes the charge (11). When the explosion happens, the gas expands inside cylinder (9) and piston (10) gets pushed with a great force. This results in positioning the ‘impact absorption plate’ (3) in perpendicular position and resulting in it getting locked in grooves (16) and (8). This shield when deployed is shown in FIG. 4. This all happens in a very short duration of couple of milliseconds, just enough to deploy the shield before collision. When the collision happens, the impact zone gets hit first and absorbs energy. Then the ‘impact absorption plates’ (3) crumple under the great force of collision, which further absorbs lot of energy, subsequently remaining energy is transferred to the ‘bumper’ and ‘crumple zone’ of the vehicle.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A method for automatically scanning and detecting the ‘imminent collision’ with moving or stationary objects in a pre determined ‘hazard zone’ around the shield and deploying the shield around the vehicle before the collision happens.

2. A method as recited in claim 1, wherein all the moving or stationary objects in the ‘hazard zone’ around the shield are continually scanned for their ‘relative speed’ and ‘distance’ with respect to the vehicle with shield.

3. A method as recited in claim 2, wherein the ‘hazard zone’ is expanded or shrunk based upon the parameters like ‘relative speed’ and ‘distance’ of the moving or stationary objects with respect to the vehicle, detected by the prior-art sensors.

4. A method as recited in claim 3, wherein the base of the ‘shield’ is attached to the vehicle on any of the locations, front, rear or both the sides.

5. A method as recited in claim 4, wherein the ‘shield’ is an integral part of the vehicle with ‘base’ connected to any of the locations, front, rear and both the sides.

6. A method as recited in claim 5, wherein the ‘shield’ is deployed around the vehicle using the electromechanical devices when ‘imminent collision’ condition is detected by the shield's ‘embedded microprocessor’.

7. A method as recited in claim 6, wherein the ‘shield’ contains a prior-art ‘embedded microprocessor’, which is situated in the ‘base’ of the ‘shield’ and is running prior-art ‘embedded software’ for detecting the condition of ‘imminent collision’ before the collision happens.

8. A method as recited in claim 7, wherein the front of the shield's ‘impact zone’ consists of a shock absorbing material.

9. A method as recited in claim 8, wherein the front of the shield contains lots of prior-art sensors that detect the ‘relative speed’ and ‘distance’ of the vehicle with respect to the stationary and moving objects in a ‘hazard-zone’ around the shield.

10. A method as recited in claim 9, wherein the ‘imminent collision’ condition is detected by the ‘embedded microprocessor’ running ‘embedded software’ by constantly analyzing the inputs from the sensors located in the ‘impact zone’.

11. A method as recited in claim 10, wherein the ‘impact absorbing plate-positioning system’ has a piston which can be pushed out of it's assembly by exploding a charge.

12. A method as recited in claim 11, wherein the explosion is triggered by a signal line, which is controlled by the ‘embedded microprocessor’, when ‘imminent collision’ is detected.

13. A method as recited in claim 12, wherein the ‘impact absorption plates’ are forced to ‘latch’ into the ‘impact zone’ by the ‘piston’ a part of the ‘impact absorbing plate-positioning system’ prior to the collision. This is timed by ‘embedded microprocessor’ such that the ‘impact absorption plates’ are ‘latched’ into the ‘impact zone’ prior to the ‘collision’.

14. A method as recited in claim 13, wherein the ‘impact zone’ of the shield moves forward out of the vehicles boundaries, when the ‘impact absorption plates’ latch into the ‘groove’ in the ‘impact zone’.

15. A method as recited in claim 14, wherein the ‘impact zone’ and latched ‘impact absorption plates’ absorb most the force of the impact and crumple when the ‘collision’ happens. This minimizes the energy that is transferred to the vehicle.

16. A method as recited in claim 15, wherein most of the shield is destroyed and absorbs most of the energy of the collision in that process and saves the occupants of the vehicles from injuries.
